(19) United States
(12) Patent Application Publication
(10) Pub. No.: US 2024/0392409 A1
(43) Pub. Date: Nov. 28, 2024

(54) METHODS OF SEPARATING METALS FROM A LITHIUM-ION BATTERY LEACHATE

(71) Applicant: Battelle Energy Alliance, LLC, Idaho Falls, ID (US)

(72) Inventors: John R. Klaehn, Idaho Falls, ID (US); Luis A. Diaz Aldana, Idaho Falls, ID (US); Tedd E. Lister, Cotuit, MA (US); Joshua S. McNally, Idaho Falls, ID (US); Meng Shi, Idaho Falls, ID (US); Daniel E. Molina Montes De Oca, Idaho Falls, ID (US)

(21) Appl. No.: 18/689,835

(22) PCT Filed: Sep. 8, 2022
(86) PCT No.: PCT/US2022/076134

§ 371 Date: Mar. 6, 2024

Related U.S. Application Data
(60) Provisional application No. 63/260,988, filed on Sep. 8, 2021.
(60) Provisional application No. 63/347,116, filed on May 31, 2022.

(51) Int. Cl. C22B 3/00; C22B 7/00; C22B 26/12; H01M 10/0525; H01M 10/54

(52) U.S. Cl. CPC C22B 23/0484; C22B 7/007; C22B 23/0461; C22B 26/12; H01M 10/0525; H01M 10/54

(57) ABSTRACT

A method of separating metals from a lithium-ion battery leachate includes obtaining a solution with iron, aluminum, nickel, and cobalt. Ammonium phosphate is added to the solution to adjust a pH of the solution to greater than or equal to about 3.00. After adjusting the pH of the solution, at least one phosphate—including iron phosphate and aluminum phosphate—is precipitated from the solution. Then, without adding a base to the solution, a crystallized nickel-cobalt Tutton's salt is precipitated from the solution.

### CROSS-REFERENCE TO RELATED APPLICATIONS

This application is a national phase entry under 35 U.S.C. § 371 of International Patent Application PCT/US2022/076134, filed Sep. 8, 2022, designating the United States of America and published as International Patent Publication WO 2023/039486 A1 on Mar. 16, 2023, which claims the benefit of the filing date under Article 8 of the Patent Cooperation Treaty of U.S. Provisional Patent Application Ser. No. 63/260,988, filed Sep. 8, 2021, for “Methods of Separating Metals from a Lithium Ion Battery Leachate,” and also claims priority to U.S. Provisional Patent Application Ser. No. 63/347,116, filed May 31, 2022, for “Metal Impurity Removal from Lithium-Ion Battery Leachates.”

### STATEMENT REGARDING FEDERALLY SPONSORED RESEARCH OR DEVELOPMENT

This invention was made with government support under Contract Number DE-AC07-05-ID14517 awarded by the United States Department of Energy. The government has certain rights in the invention.

### TECHNICAL FIELD

Embodiments of the disclosure relate generally to chemical separations. More particularly, embodiments of the disclosure relate to methods of precipitating metal species from a lithium-ion battery leachate.

### BACKGROUND

A growing need for lithium-ion batteries (LIBs) in multiple technology sectors is applying pressure on the cost and availability of the materials used in battery components, such as a demand for the metals used for battery electrodes. Correspondingly, a rise in demand for critical materials and continuous changing battery chemistries and a desire for sustainable resource management has resulted in an ongoing need for new technologies for processing and recovering materials from LIBs. This need is also driven by the growing quantity of used LIBs. It is expected that the increasing demand for electric vehicles will generate over 1.2 million tons of end-of-life LIBs in 2030, which is a six-fold increase from 2018. Because of this, up to 400,000 tons, or even up to 1 million tons, of generated LIB production scrap could be available for recycling in the coming years. Since 2019, approximately two dozen international battery recycling companies have been operating at the commercial or pilot scale, with a current process capacity of about 100,000 tons of LIB waste per year. However, in North America, the current recycling rates are only about 5%. There are multiple reasons why recycling rates remain low, including issues with collection, transportation, and storage of LIB waste material. However, a significant bottleneck in developing a circular economy for LIBs is the lack of cost-effective metals separations and recovery methods.

Previous efforts to recover metals from used batteries (e.g., end-of-life LIBs) have typically followed a hydrometallurgical process in which LIBs are discharged and dismantled to remove plastic and metallic shells, subjected to leaching to form leachates (also referred to herein as “leachate solutions” or more simply as “solutions”), and then subjected to metals separation to attempt to recover metals from the leachates, which typically include multiple metals in solution. Some conventional metals separation techniques involve precipitation of metals salts from the leachates. For example, known techniques include precipitation of impurity metals (e.g., iron, aluminum) from solutions that include phosphate/phosphoric acid. Other known techniques include precipitation and/or crystallization of desired metals (e.g., cobalt, nickel) using ammonium sulfate. The aforementioned two known techniques have been used independently of each other. Also, conventional separations techniques typically involve precipitation of metal salts by adjusting the pH of the solution (i.e., the leachate), which generally results in concurrent precipitation (e.g., co-precipitation) of multiple metals from the solution. Co-precipitation of the metals tends to result in low purities, and the conventional techniques for pH adjustments generally use large quantities of chemicals and generate large quantities of waste.

In light of the foregoing issues, metals separation by precipitation has not yet been developed on a commercial scale for processing complex, mixed-metal solutions, like the multiple-metals solutions (e.g., leachates) derived from LIBs. As a result, conventional processes have not enabled battery recyclers to capitalize on the generation, recycling, or other recovery of high-purity metal products from LIBs.

### BRIEF SUMMARY

Embodiments of the disclosure include methods of separating metals from a lithium-ion battery leachate. A method includes obtaining a solution comprising iron (Fe), aluminum (Al), nickel (Ni), and cobalt (Co). Ammonium phosphate is added to the solution to adjust a pH of the solution to greater than or equal to about 3.00. After adjusting the pH of the solution to greater than or equal to about 3.00, at least one phosphate precipitate is precipitated from the solution. The at least one phosphate precipitate comprises iron phosphate and aluminum phosphate. Then, without adding a base to the solution, a crystallized nickel-cobalt Tutton's salt is precipitated from the solution.

In some embodiments, a method includes obtaining a leachate that includes metals of interest. An ammonium salt is added to the leachate to increase the pH of the solution. At least one phosphate precipitate is precipitated from the leachate. The at least one phosphate precipitate is removed from the pH-adjusted leachate. Then, without adding a base, at least one crystallized nickel-cobalt Tutton's salt is precipitated.

According to some embodiments, a method includes obtaining a solution comprising iron (Fe), aluminum (Al), nickel (Ni), and cobalt (Co) at a pH of about 1.00 to about 2.00. Ammonium phosphate is added to the solution to adjust the pH of the solution to greater than or equal to about 3.00. At least one phosphate is precipitated from the solution. The at least one phosphate comprises iron phosphate and aluminum phosphate. Without adding a base to the solution, nickel-cobalt Tutton's salts are crystallized from the solution.

Also disclosed is a method that includes removing copper from an aqueous solution that includes multiple metals of interest. Ammonium phosphate is added to the solution to adjust the pH to between about 3 and 4. A dark blue or violet precipitate is precipitated and dissolved. The solution is heated and agitated. Then, from the solution, a white precipitate is precipitate. The white precipitate comprises iron phosphate and aluminum phosphate. Without increasing the pH of the solution, nickel-cobalt Tutton's salts are crystallized from the solution.

Moreover, disclosed is a method that includes obtaining a solution that includes multiple metals of interest and is substantially free of copper. During a phosphate precipitation stage, ammonium phosphate is added to the solution. Hydrogen peroxide and/or ammonium hydroxide may also be added. The phosphate precipitation stage precipitates iron phosphate, aluminum phosphate, and, in some embodiments, zinc phosphate. After the phosphate precipitation stage, the solution is filtered to remove the phosphate precipitate(s). Then, the solution is subjected to sulfate crystallization to recover nickel and cobalt. The sulfate crystallization does not include the addition of any bases or otherwise increasing the pH of the solution. During the sulfate crystallization portion of the method, in at least some embodiments, ammonium sulfate is added. At room temperature, a nickel-rich Ni/Co Tutton's salt is precipitated from the solution. Then, at a reduced temperature, a cobalt-rich Ni/Co Tutton's salt is precipitated from the solution.

### BRIEF DESCRIPTION OF THE DRAWINGS

While the specification concludes with claims particularly pointing out and distinctly claiming what are regarded as embodiments of the disclosure, various features and advantages of this disclosure may be more readily ascertained from the following description of example embodiments provided with reference to the accompanying drawings, in which:

FIG. 1 is a flow diagram for a process of separating metals from a solution, according to embodiments consistent with this disclosure;

FIG. 2 is a flow diagram for a process of separating metals from a solution, according to embodiments consistent with this disclosure;

FIG. 3 is a flow diagram for a process of separating metals from a solution, according to embodiments consistent with this disclosure; and

FIG. 4 is a flow diagram for a process of separating metals from a solution, according to embodiments consistent with this disclosure.

### DETAILED DESCRIPTION

A lithium-ion battery leachate, which may be obtained from one or more used lithium-ion batteries (LIBs), may include multiple metals in (e.g., dissolved in) an acidic, aqueous solution. It is desirable to recover individual metals in high-purity or otherwise targeted fractions. However, this is not always feasible using conventional processes, which tend to favor the multiple metals being removed from solution simultaneously rather than in fractions. Therefore, the recovered precipitated metals are generally of relatively low value because they are mixed salts, not pure salts or otherwise high-concentration targeted combinations of metals. Therefore, the precipitates received from conventional processes are generally not suitable for subsequent commercial use without additional processing. For example, some conventional processes include neutralization of the acid in the leachate before precipitation of the metals from the leachate solution. Where nickel and cobalt compositions are recovered from such processes, the nickel/cobalt compositions tend to be contaminated with (e.g., also include) iron, copper, and/or aluminum. In contrast, methods according to embodiments disclosed herein enable recovery of metal precipitates in individual or other targeted fractions so that metal(s) of interest may be recovered as generally high-purity metals or metal compositions suitable for reuse without significant additional purification.

Pursuant to embodiments herein, ammonium phosphate is added to a leachate solution (e.g., an obtained leachate solution) to precipitate impurity metals (e.g., iron (Fe), aluminum (Al) and, optionally, zinc (Zn)) from the solution. Then, metals of interest (e.g., nickel (Ni) and cobalt (Co)) are crystallized from the solution. Accordingly, the methods disclosed herein include a two-stage process of, first, phosphate precipitation and, second, nickel/cobalt crystallization.

In some embodiments, about 90 weight % (wt. %) of the iron (Fe) and aluminum (Al) from the original leachate solution may be recovered in the phosphate precipitation stage, with minimal loss of cobalt (Co), nickel (Ni), manganese (Mn), and lithium (Li) in the phosphate precipitates. In these or some other embodiments, about 90 wt. % of the cobalt and about 99 wt. % of the nickel from the original leachate solution may be recovered in the nickel/cobalt crystallization stage.

As used herein, the term “leachate” means and refers to a solution (e.g., an aqueous solution) that includes multiple metals therein. The metals may be dissolved or otherwise dispersed (e.g., substantially dissolved, partially dissolved, suspended) in the aqueous solution. Therefore, the solution may, in actuality, be a colloid, a suspension, etc. A “leachate” may otherwise be referred to herein as a “leachate solution” or simply as a “solution.”

As used herein, the terms “method” and “process” may be used interchangeably.

As used herein, the terms “stage” and “act” may be used interchangeable. Moreover, a described or illustrated “stage” or “act” may include one or more than one sub-stage or sub-act.

As used herein, the singular forms “a,” “an,” and “the” are intended to include the plural forms as well, unless the context clearly indicates otherwise.

As used herein, “and/or” includes any and all combinations of one or more of the associated listed items.

As used herein, the term “substantially” in reference to a given parameter, property, or condition means and includes to a degree that one skilled in the art would understand that the given parameter, property, or condition is met with a small degree of variance, such as within acceptable manufacturing tolerances. For example, a parameter that is substantially met may be at least about 90% met, at least about 95% met, or even at least about 99% met.

As used herein, the term “substantially all” means and includes greater than about 90%, such as greater than about 95% or greater than about 99%.

As used herein, the term “about” in reference to a numerical value for a particular parameter is inclusive of the numerical value and a degree of variance from the numerical value that one of ordinary skill in the art would understand is within acceptable tolerances for the particular parameter. For example, “about” in reference to a numerical value may include additional numerical values within a range of from 90.0 percent to 110.0 percent of the numerical value, such as within a range of from 95.0 percent to 105.0 percent of the numerical value, within a range of from 97.5 percent to 102.5 percent of the numerical value, within a range of from 99.0 percent to 101.0 percent of the numerical value, within a range of from 99.5 percent to 100.5 percent of the numerical value, or within a range of from 99.9 percent to 100.1 percent of the numerical value.

As used herein, the terms “comprising,” “including,” “containing,” “characterized by,” and grammatical equivalents thereof are inclusive or open-ended terms that do not exclude additional, unrecited elements or method acts, but also include the more restrictive terms “consisting of” and “consisting essentially of” and grammatical equivalents thereof.

As used herein, the term “may” with respect to a material, structure, feature, or method act indicates that such is contemplated for use in implementation of an embodiment of the disclosure and such term is used in preference to the more restrictive term “is” so as to avoid any implication that other, compatible materials, structures, features and methods usable in combination therewith should or must be excluded.

The flow chart illustrations presented herein are not meant to be comprehensive illustrations of all acts within the method(s) but are general representations illustrating stages or acts within the method and the general relation, thereof, to one another. In some embodiments, for any particular stage or act, during the duration between a particular stage or act and a next particular stage or act, or otherwise during an entirety of the process illustrated or described, no additional chemicals, compositions, or other material(s) may be added into the solution except for those that are expressly described and/or illustrated. In other embodiments, any particular stage or act may include, be proceeded by, or be followed by one or more additions of not-expressly described or illustrated chemical(s), composition(s), or other material(s).

According to methods described and illustrated herein, metals are separated and recovered from a leachate (e.g., an aqueous leachate solution) by adding at least one water-soluble salt—which may include one or more ammonium salts, one or more phosphate salts, or both (e.g., ammonium phosphate salt(s))—to precipitate metal salts in distinctive fractions from the solution. The ammonium salt(s) and/or phosphate salt(s) (e.g., ammonium phosphate salt(s)) added to the solution may comprise, consist essentially of, or consist of ammonium phosphate salt(s). In some embodiments, the ammonium salts added to the leachate further include ammonium sulfate(s), though added in a separate stage of the process than the addition of ammonium phosphate salt(s).

Prior to the salt additions, the metals are initially soluble in (e.g., dissolved in) the leachate solution and include one or more metals of interest, such as nickel (Ni), cobalt (Co), iron (Fe), and aluminum (Al). In some embodiments, the metals in the solution may also include zinc (Zn) and manganese (Mn). Also, prior to the salt additions, the leachate may be substantially free of copper (Cu) and, in some embodiments, also substantially free of carbon (C), such as by application of known techniques for removing such species.

During the method, the addition of the ammonium phosphate salt changes a pH of the leachate from its initial pH and may form insoluble compounds (e.g., insoluble salts, precipitates) with specific metals in the pH-adjusted leachate, such as “impurity” metals (e.g., iron (Fe), aluminum (Al), and, optionally, zinc (Zn)). Following the addition of the ammonium phosphate salt, the ammonium phosphate salt may selectively form the insoluble compounds with the specific metals, without forming compounds with other metals, such as the metals of interest (e.g., nickel (Ni) and cobalt (Co), in the leachate and/or without forming other insoluble compounds with the metals of interest (e.g., Ni and Co). The specific metals that precipitate as a result of the addition of the ammonium phosphate salt may be considered contaminants (e.g., impurities) in the leachate. Once precipitated, the insoluble compounds (e.g., phosphate salts, such as iron phosphate, aluminum phosphate, and, in some embodiments, zinc phosphate) may be removed from the pH-adjusted leachate, such as by filtration.

After removing the insoluble compounds, one or more of the metals of interest are then separated and recovered from the pH-adjusted leachate. The one or more metals of interest may be separated and recovered without adding strong bases (e.g., without adding NaOH) to the leachate. In some embodiments, provided the pH of the leachate post removal of the phosphate precipitates (e.g., comprising the impurity metals) is at least about 2.00, the pH of the leachate is not thereafter otherwise increased (e.g., no additional base(s) or other pH-increasing species are added to the leachate) prior to or during recovery of the metals of interest. In recovering the metals of interest from the leachate, the one or more metals of interest may be recovered sequentially (e.g., separately from one another) or as a single fraction (e.g., together with one another).

While embodiments herein describe separating and recovering iron (Fe), aluminum (Al), zinc (Zn), nickel (Ni), cobalt (Co), and manganese (Mn) from a lithium-ion battery (LIB) leachate, the disclosure is not so limited. The disclosed methods, or methods similar thereto, may be alternatively or additionally used to separate and recover other impurity metals and/or metals of interest from leachates. Moreover, additional metals (e.g., lithium (Li)) may be subsequently recovered from the solution that remains after removing the impurity metals and metals of interest by the stages described herein.

According to embodiments herein, a method for separating impurity metals from the leachate includes using a pH of from about 3 (e.g., about 3.0, about 3.00) to about 4 (e.g., about 4.0, about 4.00)—such as from about 2.8 to about 4.3—to achieve separation of iron (Fe) and aluminum (Al) from nickel (Ni) and cobalt (Co) dissolved in a leachate derived from one or more lithium-ion batteries (LIBs). This separation stage (and, in some embodiments, the whole of the method) may be performed with the solution having a pH below about 5, such as at a pH of about or below about 4 (e.g., about 4.0, about 4.00). At a pH of from about 3 to about 4, the iron and aluminum from the leachate rapidly precipitate as phosphate salts. While nickel and, to some extent, cobalt are also thermodynamically unstable at these conditions, the rate of precipitation for nickel and cobalt is relatively slower than that for iron and aluminum. Accordingly, the iron and aluminum may be precipitated out from the leachate solution while the nickel and the cobalt remain dissolved in the leachate solution. Surprisingly, an initial fraction containing the iron phosphate and aluminum phosphate may be precipitated and separated from the leachate (e.g., and, therefore, from the nickel and the cobalt of the leachate). Then, nickel, in the form of Tutton's salts that also include cobalt (and may, therefore, be referred to herein as “Ni/Co Tutton's salts”), crystallizes over a relatively longer time frame-compared to the precipitation of the iron and aluminum phosphates-allowing nickel (and cobalt) recovery as a separate fraction from the iron and aluminum. Though the Ni/Co Tutton's salts crystallize, and precipitate, over a relatively longer time frame compared to the formation and precipitation of the iron and aluminum phosphate salts, the Ni/Co Tutton's salts' crystallization and precipitation may be completed in a significantly shorter time frame compared to conventional metals separation methods, such as being completed within a period of about fifteen minutes (15 min.) for a nickel-rich Ni/Co Tutton's salt and such as within about three days (3 d.) (e.g., about 2 d.) for a cobalt-rich Ni/Co Tutton's salt.

The leachate solution, as obtained before the stage of precipitating phosphate salts (e.g., of iron and aluminum), may have a pH of less than about 2.00, such as a pH between about 1.00 and about 2.00. To adjust the pH of the leachate to a range from about 3.00 to about 4.00—for the precipitation of the phosphate salts of the impurity metals—a water-soluble phosphate salt, such as an ammonium phosphate salt, is added to the leachate. The addition of ammonium phosphate to the leachate causes the increase in pH and, as a result, the precipitation of iron phosphate, aluminum phosphate, and, in some embodiments (e.g., in embodiments in which the originally obtained leachate includes zinc) also zinc phosphate). The addition of the phosphate salt (e.g., the ammonium phosphate) also produces a relatively slower crystallization of nickel (Ni) as a Tutton's salt that also includes cobalt (Co).

Tutton's salts have a general formula of (NH₄⁺)₂M²⁺(SO₄)₂*6H₂O, where “M” is a mixed transition metal composition to form a double salt. As used herein, the terms “Tutton's salt” and “double salt” may be used interchangeably.

Because, in embodiments described herein, the Tutton's salt crystallizes and precipitates significantly slower than the formation and precipitation of the phosphate salts (e.g., the Fe phosphate, the Al phosphate, and, in come embodiments, the Zn phosphate salts), the difference in kinetic rates (e.g., formation of phosphate salt(s) versus crystallization of Tutton's salt(s)) enables the effective separation of the nickel salts (e.g., the Ni/Co Tutton's salt(s)) from the other metal salts (e.g., the impurity metal phosphate salts). Therefore, an iron phosphate/aluminum phosphate (and, in some embodiments, also a zinc phosphate) fraction is initially precipitated from the leachate and then, the remaining solution may be decanted, following which a portion of the nickel (and cobalt) fraction crystallizes. In some embodiments, the nickel (and cobalt) crystallization may occur without any additional chemical additions to the leachate. In other embodiments, additional water-soluble salt(s) (e.g., ammonium sulfate) is added to the leachate (post removal of the phosphate precipitates); however, no base(s) (e.g., no NaOH) is (are) added, and the pH of the leachate is not otherwise chemically increased before the nickel (and cobalt) crystallization.

Thus, the difference in kinetics allows for effective separation of the nickel crystals (e.g., the nickel salts, e.g., the nickel/cobalt Tutton's salts) from the iron and aluminum (and, in some embodiments, zinc) precipitates (e.g., the iron, aluminum, and, in some embodiments, zinc salts). This allows recovery of the nickel (and cobalt) as a valuable fraction of the leachate. Without being bound to any particular theory, it is contemplated that the difference in kinetics may be the result of the added phosphate not associating as well with the nickel (and cobalt) as sulfates associate with the nickel (and cobalt). Accordingly, iron and aluminum (and, in some embodiments, zinc) with phosphate had relatively stronger association kinetics at pH 3 to 4 compared with other metals in the leachate (e.g., such as the nickel and cobalt).

The described process(es), according to embodiments of the disclosure, offer(s) a number of advantages. For example, the use of ammonium phosphate for the phosphate precipitation stage(s) allows for relatively fewer chemicals to be used (e.g., added to the leachate) to obtain the two fractions, compared with conventional approaches. The process(es), according to embodiments of the disclosure, also avoid(s) adding either or both sodium (Na) and potassium (K) ions to the leachate, which additions would otherwise make isolation of a lithium fraction from the final remaining leachate solution more challenging downstream. Moreover, the nickel (and cobalt) fraction is isolated as a sulfate, which is a high-value form of the nickel (and cobalt). The process(es), according to embodiments of the disclosure, may use a single process (e.g., a single pass of leachate) to precipitate the iron and aluminum (and, in some embodiments, zinc) fraction and the nickel (and cobalt) fraction from the lithium-ion battery leachate. Furthermore, because the water-soluble salt additives used in the process (e.g., the ammonium phosphate salt(s), and, in some embodiments, the ammonium sulfate salt(s)) may be added in solid (non-solution) form—rather than adding water-containing solutions—to alter the pH of the leachate, the addition of water (e.g., liquid H₂O) may be avoided in the method, which may facilitate a relatively low volume of material waste resulting from the process. In some embodiments, substantially no water (e.g., no H₂O) is added to the leachate during the stages of the process from adding a phosphate salt to initiate the precipitation of the phosphate salts (e.g., the iron phosphate, the aluminum phosphate, and, in some embodiments, the zinc phosphate) to collecting the nickel (and cobalt) Tutton's salt(s). In other words, in some embodiments, no additional water is added beyond that already present in the leachate solution as obtained.

The following description provides specific details, such as material compositions and processing conditions (e.g., temperatures, pressures, flow rates, etc.) in order to provide a thorough description of embodiments of the disclosure. However, a person of ordinary skill in the art will understand that the embodiments of the disclosure may be practiced without necessarily employing these specific details. Indeed, the embodiments of the disclosure may be practiced in conjunction with conventional systems and methods employed in the industry. In addition, only those process components and acts necessary to understand the embodiments of the disclosure are described in detail below. A person of ordinary skill in the art will understand that some process components (e.g., pipelines, line filters, valves, temperature detectors, flow detectors, pH sensors, and the like) are inherently disclosed herein and that adding various conventional process components and acts would be in accord with the disclosure.

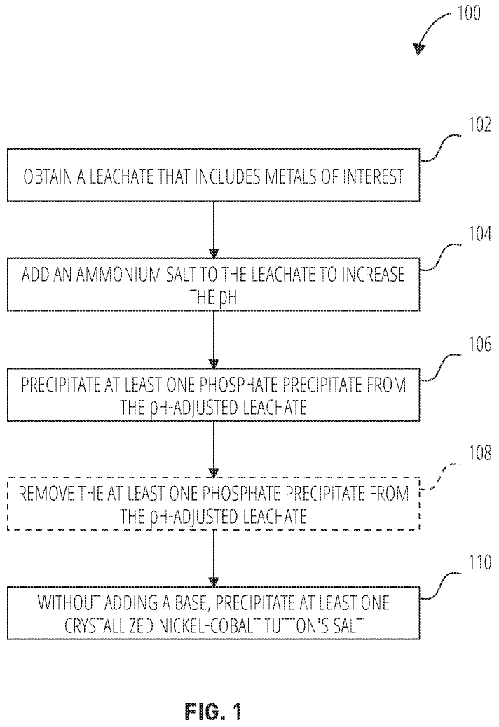

FIG. 1 is a flow diagram for a process 100 (e.g., a process) of separating metals from a solution, according to embodiments consistent with this disclosure. The metals to be separated may include iron (Fe), nickel (Ni), and cobalt (Co), and the solution—as originally obtained for performing the method—may be a lithium-ion battery leachate with the metals dissolved therein.

The process 100 includes an act 102 of obtaining a leachate that includes metals of interest. The leachate may be a lithium-ion battery leachate. The leachate may be an acidic solution (e.g., an acidic aqueous solution), having an initial pH between about 1.0 and about 2.0. In some embodiments, the leachate includes metals that will, during further acts of the process 100, precipitate as phosphate salts at a pH of about 3.0. For example, the leachate may include iron (Fe) and/or aluminum (Al). The leachate may also include metals of interest, for example, nickel (Ni), cobalt (Co), and, in some embodiments, other metals of interest. The metals are initially soluble in the leachate.

In some embodiments, the leachate initially derived from the LIB(s) may further include copper and/or carbon in addition to the metals to be separated during the process 100. In such embodiments, the copper, if initially present, and the carbon, if initially present, may be removed from the leachate to obtain the leachate (e.g., act 102) to be subjected to the remainder of the process 100. The copper (Cu) and/or carbon (C) may be removed using known techniques such as electrochemical leaching, which may result in obtaining a leachate that includes the metals of interest dissolved in an aqueous, acidic solution while being substantially free of at least copper (Cu) and, optionally, also substantially free of carbon (C).

Once the leachate has been obtained (act 102), a water-soluble salt—such as an ammonium salt, according to the embodiment of FIG. 1—is added to the leachate to increase the pH of the leachate (act 104). The ammonium salt may be an ammonium phosphate. The ammonium salt may be added in the form of a solid material (e.g., solid particles) without addition of further liquid (e.g., water) into the leachate.

As described above, the addition of the ammonium salt (act 104) causes at least one phosphate precipitate (e.g., at least one metal phosphate precipitate) to form and precipitate from the leachate (act 106) at a faster rate than it causes other metals in the leachate to become insoluble. More particularly, the addition of the ammonium salt (act 104) changes (e.g., increases) the pH of the leachate from its initial pH such that certain compounds (e.g., insoluble salts, precipitates) of specific metals (e.g., impurity metals) form and are insoluble in the pH-adjusted leachate. In some embodiments, the addition of the ammonium salt(s) increases the pH of the leachate to about 3.0 (e.g., from about 3.0 to about 4.0). The pH of the leachate may be controlled (e.g., by controlling the amount of ammonium salt added) to keep the pH of the leachate to about or less than 5.0 (e.g., about or less than 4.0). In some embodiments, the pH is controlled to be between about 3 and about 4 as a result of act 104.

The process 100 also includes an act 106 of forming insoluble compounds in the pH-adjusted leachate, so that at least one phosphate salt (e.g., at least one metal-phosphate) precipitates out of the pH-adjusted leachate solution. The insoluble compounds may comprise, consist essentially of, or consist of, e.g., iron phosphate, aluminum phosphate, and/or zinc phosphate. In some embodiments, the insoluble compound(s) (e.g., the at least one phosphate precipitate) resulting from act 106 may be Tutton's salt(s). Following the addition of the ammonium salt to the leachate (act 104), the ammonium salt may selectively form the insoluble compounds with the specific metals (e.g., impurity metals Fe, Al, and/or Zn), without forming compounds with other metals, such as the metals of interest (e.g., Ni, Co), in the leachate and/or without causing other insoluble compounds that include the metals of interest to form before the metal-phosphate compounds (comprising the impurity metal(s)) have precipitated out of the pH-adjusted leachate solution. The specific metals that form the phosphate precipitates in act 106 may be considered contaminants (e.g., impurities) in the leachate.

In some embodiments, after the at least one phosphate precipitates from the leachate, the leachate (e.g., the pH-adjusted leachate) may be subjected to an act 108 for removing the phosphate precipitate(s) (e.g., the insoluble compounds) from the leachate (e.g., from the pH-adjusted leachate). Act 108 may include centrifuging the leachate to collect the insoluble compounds, for example, at the bottom of a container, and then the insoluble compounds may be removed from the pH-adjusted leachate, such as by filtration. The insoluble compounds may be subjected to further processing in separate acts outside of the process 100. In some embodiments, the insoluble compounds (e.g., the phosphate precipitates) separated from the leachate may form the basis of a fertilizer.

After precipitating the at least one phosphate from the leachate to substantially separate the impurity metal(s) (e.g., iron (Fe), aluminum (Al), and/or zinc (Zn)) from the leachate (acts 106 and 108), the process 100 further includes an act 110 of recovering one or more metals of interest from the pH-adjusted leachate. The metals of interest (e.g., nickel, cobalt) may be recovered as precipitates from the leachate remaining after acts 106 and 108. In some embodiments, the metal precipitates may be in the form of Tutton's salt(s), such as crystallized nickel-cobalt Tutton's salt(s) (e.g., Ni/Co Tutton's sulfate salt(s)). The metals of interest may be separated from the pH-adjusted leachate in a single fraction or in multiple sequential fractions. The metals of interest may be precipitated without adding a base to the leachate.

Accordingly, the process 100 may be used to separate and recover metals such as iron (Fe), aluminum (Al), zinc (Zn), cobalt (Co), and/or nickel (Ni) from lithium-ion battery (LIB) leachate. The process 100 or similar processes may also be used to separate and recover other metals (e.g., other metals of interest) from the leachate, either in the same process 100 as removing Fe, Al, Zn, Co, and/or Ni, or in an additional implementation of the process 100.

As a more particular example, for illustration purposes, the process 100 may be used with an LIB leachate to remove iron, aluminum, cobalt, and nickel from the leachate solution. Such LIB leachate may be obtained from spent (e.g., discharged) lithium-ion batteries that have been dismantled to remove plastic and some metallic components (e.g., copper) and leached to form and obtain the LIB leachate (act 102). The lithium-ion batteries may be dismantled and leached using conventional techniques to obtain the leachate (act 102). The lithium-ion battery leachate, as obtained for use in the process 100, may include multiple metals that are dissolved in (e.g., soluble in) the lithium-ion battery leachate, which metals may include aluminum (Al), iron (Fe), cobalt (Co), nickel (Ni), lithium (Li), and/or manganese (Mn). The lithium-ion battery leachate may be substantially free of copper (Cu) and, in some embodiments, also substantially free of carbon (C, such as graphite) to obtain the leachate (act 102) to be used in the remainder of the process 100. The lithium-ion battery leachate as obtained (act 102) (e.g., after removal of copper (Cu) and, optionally, carbon (C)) may initially (e.g., as produced) have a pH of greater than or equal to about 1 and less than or equal to about 2. Therefore, the lithium-ion battery leachate, as obtained (act 102), may exhibit an initial pH of between about 1.0 and about 2.0, such as between about 1.00 and about 2.00. The initial pH may be between about 1.0 and about 1.5, between about 1.5 and about 2.0, between about 1.1 and about 1.6, between about 1.2 and about 1.7, between about 1.3 and about 1.8, or between about 1.4 and about 1.9. The obtained leachate (act 102) may include aluminum (Al), iron (Fe), and, in some embodiments, zinc (Zn), among other metals (e.g., metals of interest). The presence of aluminum, iron, and, in some embodiments, zinc in the LIB leachate may contaminate separated metals of interest, in later stages of the process 100, if the aluminum, iron, and, in some embodiments, zinc are not removed from the leachate prior to separating and recovering the metals of interest (e.g., nickel and/or cobalt).

An amount of ammonium salt may be added to the LIB leachate to increase the pH to between about 3.0 and about 4.0 (e.g., to between 2.8 and 4.3, e.g., to between about 2.8 and about 4.3) and form a pH-adjusted LIB leachate (act 104). The pH of the pH-adjusted LIB leachate may, for example, be between about 2.9 and 4.1, between about 2.9 and 3.2, or between about 3.8 and 4.2. The ammonium salt may be a powder or other solid material. The amount of ammonium salt added may be sufficient to raise the pH (act 104) and cause the precipitation of insoluble compounds, namely, insoluble metal phosphate salts (act 106).

In adding the ammonium salt to the leachate (act 104), a stoichiometric amount of ammonium salt may be added relative to the metals (e.g., the total metal concentration, the metal contaminants). For instance, an about 1:1 ratio (e.g., 1:1 molar ratio) of ammonium salt:total metal concentration may be used (in act 104). For example, the ratio of ammonium salt:total metal concentration may be between about 0.8:1 and about 1.2:1 of the ammonium salt:total metal concentration. The total metal concentration in the solution may be from about 30,000 parts per million (ppm) to about 70,000 ppm, such as from about 30,000 ppm to about 40,000 ppm.

The adjustment of the pH (e.g., the addition of the ammonium salt (act 104)) may be made incrementally to avoid “overshooting” the target pH of from about 3 to about 4. For instance, ammonium phosphate (e.g., monoammonium phosphate, diammonium phosphate) may be added (e.g., in solid particle form) in sequentially added portions to the LIB leachate until the pH is from about 3 to about 4.

In some embodiments, the ammonium salt added to the leachate to increase the pH to between about 3 and about 4 may be an ammonium salt other than or in addition to the aforementioned ammonium phosphate salt(s). For example, ammonium acetate may be added as the ammonium salt (act 104) to adjust the pH to about 3 to about 4. Similarly, ammonium sulfate or other ammonium salts may be used, in addition to or alternatively to the aforementioned ammonium salts, to adjust the pH of the leachate (act 104).

In some embodiments, the ammonium salt added to increase the pH may comprise ammonium phosphate and may be substantially free of ammonium sulfate and/or other ammonium compounds.

The addition of the ammonium salt results in the formation of the compounds (e.g., metal salts comprising impurity metal(s)) that become insoluble in the leachate when the leachate's pH raises to between about 3 and about 4, such that the insoluble compounds precipitate from the pH-adjusted leachate solution (act 106). The insoluble compounds may comprise, consist essentially of, or consist of phosphate precipitate(s), in embodiments in which the added ammonium salt (act 104) included ammonium phosphate; may comprise, consist essentially of, or consist of acetate precipitate(s), in embodiments in which the added ammonium salt (act 104) included ammonium acetate; and/or may comprise, consist essentially of, or consist of sulfate precipitate(s), in embodiments in which the added ammonium salt (act 104) included ammonium sulfate.

The insoluble compounds (e.g., at least one phosphate precipitate) may be subsequently removed from the pH-adjusted LIB leachate (act 108), while the metals of interest remain dissolved (e.g. substantially dissolved) in the pH-adjusted LIB leachate. Removing the insoluble compounds (e.g., the phosphate precipitate(s)) removes the metal contaminants from the pH-adjusted LIB leachate (act 108), while the metals of interest remain solubilized in the pH-adjusted LIB leachate. A majority (approximately 90 wt. %) of the metal contaminants (e.g., Fe, Al, Zn) from the originally obtained leachate (act 102) may be removed from the pH-adjusted LIB while a majority (greater than approximately 90 wt. %, greater than approximately 95 wt. %, greater than approximately 99 wt. %) of the metals of interest from the originally obtained leachate (act 102) remain dissolved in the pH-adjusted LIB leachate.

For example, in some embodiments the ammonium salt added to the leachate (act 104) may comprise, consist essentially of, or consist of diammonium phosphate, and its addition may result in a white, cloudy precipitate forming in the pH-adjusted LIB (act 106). The white, cloudy precipitate may comprise iron phosphate and/or aluminum phosphate. This precipitate may be separated from the pH-adjusted LIB leachate (act 108), for example, by centrifuging the pH-adjusted LIB leachate and decanting the pH-adjusted leachate. After removing the phosphate precipitates (act 108), the pH-adjusted leachate may still contain, dissolved therein, substantially all of the metals of interest. The pH-adjusted LIB leachate may then be maintained at a temperature of from about 10° C. to about 80° C., such as from about 40° C. to about 60° C., for an amount of time sufficient for the metals of interest to form insoluble compounds and precipitate (act 110). The compounds containing the metals of interest may be selectively precipitated by adjusting one or more of the temperature or time. For example, the pH-adjusted LIB leachate may be maintained at room temperature (from about 20° C. to about 25° C.) for about three days. During this time, the nickel may crystallize from the pH-adjusted leachate as a Tutton's salt (act 110). The crystallized nickel salt may be blue-green in color. In some embodiments, the nickel salt is mixed with a cobalt Tutton's salt. The metals of interest may, therefore, be recovered from the pH-adjusted LIB leachate without adding additional chemicals (e.g., without adding base(s) to the leachate, without chemically increasing the pH of the leachate) to the pH-adjusted LIB leachate. Instead, the metals of interest may be separated and recovered by adjusting one or more of the temperature or time following the removal of the metal contaminants (act 108).

In some embodiments, during the addition of the ammonium salt (act 104), localized formation and precipitation of insoluble compounds of the metals of interest may occur at the point of addition. For instance, a dark blue or violet colored precipitate may form at the point of addition of the ammonium phosphate to the LIB leachate. Applying heat and/or agitation to areas of this localized precipitation may enable the precipitate to be re-solubilized in the pH-adjusted LIB leachate, which enables the metals of interest to remain in solution in the leachate. If, for example, ammonium phosphate is added to the LIB leachate (act 104), any dark blue or violet precipitate that is formed may go back into solution (e.g., may re-dissolve) in the pH-adjusted LIB leachate following the application of heat and/or agitation. The dark blue or violet precipitate may be a cobalt species and may not be an iron or aluminum precipitate. The dark blue or violet precipitate may form when the ammonium phosphate is added, which may raise the local pH above about 3. As this area is homogenized by agitation and/or heating, the pH may return to a lower value (e.g., a pH between about 3 and about 4), and the dark blue or violet precipitate may dissolve back into the pH-adjusted leachate. Accordingly, the addition of the ammonium phosphate salt enables precipitation of iron phosphate and aluminum phosphate while keeping the cobalt and nickel ions in solution.

As described above, lithium-ion battery leachates contain solubilized metals and tend to be at a relatively low pH (e.g., between about 1 and about 2). This strongly acidic pH has resulted in conventional processes seeking to neutralize the leachate solution (e.g., raise the pH of the leachate solution to relatively closer to 7) prior to conducting metal separations using conventional techniques such as solvent extraction (SX), ion-exchange (IX), or electrochemical techniques. However, complete neutralization of a lithium-ion battery leachate may consume a large amount (e.g., large volume) of chemicals (e.g., bases). Further, such neutralization can shock the system, rendering the metal species more difficult to separate. For example, the addition/use of concentrated bases (e.g., concentrated NaOH) tends to result in localized precipitation of metal hydroxides (e.g., shocking) that are difficult to resolubilize into the leachate. The high chemical consumptions (e.g., additions to the leachate) involved with conventional techniques may make subsequent recovery operations more challenging and/or expensive. For example, the addition of more water to the leachate, in conventional processes, may dilute the solution, resulting in a greater quantity of material to neutralize before metals separation. Additions of sodium and/or potassium ions, in conventional techniques, may make it challenging to recover lithium from the lithium-ion battery leachate in a lithium-only fraction.

In contrast, the processes according to embodiments of the disclosure (e.g., process 100 and other processes illustrated and/or described herein) may use fewer chemicals, e.g., 50% less chemicals by mass, than conventional methods for separating iron and aluminum from the remainder of the LIB leachate. In some examples of the processes according to embodiments described herein, no additional water is introduced during the process (e.g., during process 100, and/or during other processes illustrated and/or described herein). The process (e.g., process 100 and/or other processes illustrated and/or described herein) may not add any sodium (Na) and/or any potassium (K) ions to the solution, at least between obtaining the leachate (e.g., act 102) and precipitating metals of interest (e.g., act 110).

With further regard to adding an ammonium salt to the leachate to adjust the pH of the leachate (e.g., act 104) and cause separation (e.g., precipitation) of impurity metals (e.g., act 106), such as iron, iron (III) will precipitate in the presence of ammonium phosphate. Therefore, iron (III) may be substantially separated (act 106) and removed from (act 108) the leachate solutions, even at a pH of about 3. As a result, iron may be removed from the LIB leachate without creation of a neutral pH (e.g., without raising the pH of the leachate to a pH near to about 7, such as to a pH above about 5). In addition, aluminum phosphate salt may form a polymeric structure, which may precipitate from solution (e.g., in act 106). Even at a pH of about 3, aluminum phosphate is not extremely soluble in the pH-adjusted leachate. Accordingly, adjusting the pH of the leachate to about 3 may result in precipitation of the iron phosphate and/or aluminum phosphate from the leachate (act 106). This precipitation of iron phosphate and/or aluminum phosphate (act 106) may be relatively rapid, e.g., substantially completed within about thirty minutes (30 min.), upon reaching a pH of about 3 following the ammonium phosphate addition (act 104).

Copper is not readily precipitated from LIB leachate at a pH of about 3. Rather, copper generally needs a nearly neutral pH (e.g., a pH of about 7, such as a pH greater than about 5) for its phosphate precipitation. A separate extraction act may be conducted to remove the copper, such as by known techniques using sequential ion exchange (IX) or solvent extraction (SX) systems, to obtain the leachate (act 102) to be used in the process (e.g., the process 100). In some embodiments, the leachate is produced (e.g., leached from the LIBs) without significant copper in the leachate. For example, leaching LIBs may create (e.g., obtain) suitable leachate solutions for use in the process (e.g., the process 100). In alterative embodiments, the leachate—as leached from LIB materials—may include copper. If kept in the leachate solution, the copper may interfere with downstream processes. For example, copper may contaminate fractions of later-separated metals of interest, such that it may be difficult to obtain high-purity fractions of metals of interest due to the copper in the solution. Accordingly, as discussed above, the copper may be substantially removed from the leachate to obtain a leachate (act 102) suitable for use in the process (e.g., process 100). One approach to minimize the copper in the obtained leachate is the process described in Diaz, L. A.; Strauss, M. L.; Adhikari, B.; Klaehn, J. R.; McNally, J. S.; Lister, T. E., “Electrochemical-Assisted Leaching of Active Materials from Lithium-Ion Batteries,” Resources, Conservation and Recycling 2020, 161, 104900. The described approach can be used to generate (e.g., obtain) leachate solutions (act 102) with minimal copper in the leachate allowing for subsequent processing without the copper interfering in the separations.

Without being bound by any theory, the use of an ammonium salt (e.g., ammonium phosphate) (e.g., in act 104) may help avoid pH “shock” to the leachate. So-called pH “shock” commonly occurs during conventional techniques of recovering metals from LIB leachates. The pH shock of the conventional techniques may result from adding a strong neutralizing agent (e.g., a base, such as NaOH), which produces a local change in the pH (e.g., a significantly increased pH at the point of addition of the strong neutralizing agent), triggering a precipitation that is difficult to reverse. The term “pH shock” means that precipitates (e.g., metal oxides) are formed substantially immediately in solution once the base (e.g., strong NaOH) is added during the conventional techniques. These metal oxides tend to be difficult to redissolve into solution. In contrast, the ammonium salt(s) used in embodiments of this disclosure (e.g., at act 104) may reduce the likelihood of such “pH shock.” Therefore, using ammonium phosphates to adjust the pH (act 104) may retain higher-value metals (e.g., nickel, cobalt) in the leachate. The addition of ammonium phosphate does not appear to trigger non-reversible precipitation of the cobalt. Rather, in examples in which the aforementioned deep blue or violet precipitate forms due to addition of the ammonium phosphate (in act 104), the deep blue or violet precipitate may be re-solubilized into the leachate by agitation and/or heating.

In some embodiments, the addition of the ammonium salt to the leachate (act 104) results in formation of a white (e.g., a gray-white) precipitate of fine solids (in act 106) after the pH has been adjusted to about 3. This precipitate may be recovered (in act 108), e.g., by centrifugation or gravity/vacuum filtration of the solution and then decanting off the liquid. The white precipitate may contain iron phosphate and aluminum phosphate. In some examples, the precipitate contains most of the iron and aluminum from the obtained solution (obtained in act 102), e.g., at least about 90 wt. % of the iron and aluminum from the obtained leachate, or at least about 95 wt. % of the iron and aluminum from the obtained leachate. The ability to remove almost all the iron and aluminum as phosphate precipitates (act 106) allows effective separation of the iron and aluminum from the remaining components of the solution, e.g., nickel, cobalt, manganese, and lithium.

After precipitation of the insoluble metal compounds that comprise the impurity metals (e.g., Fe, Al, and, in some embodiments, Zn) (act 106) and, in some embodiments, after removal of these precipitates from the pH-adjusted leachate (act 108), the leachate solution may be allowed to cool—or may be actively cooled—to about room temperature (from about 20° C. to about 25° C.) without agitation. In these embodiments, the leachate solutions may have been kept relatively warm during the removal of the impurity metal-compound precipitates (act 108).

In a particular example, after removal of the impurity metal precipitates, the remaining leachate solution spontaneously formed a blue-green crystal (act 110), which was identified, via chemical analysis, as a nickel Tutton's salt. No additional chemicals (including no additional base(s)) were added to induce the crystallization of the nickel Tutton's salt. Surprisingly, the kinetics of deposition for the impurity metals (e.g., Fe, Al, and/or Zn) and the metals of interest (e.g., Ni, Co) were such that they could be recovered separately from the same leachate solution. More specifically, the white precipitate containing iron phosphate and aluminum phosphate had a relatively short precipitation time, while the kinetics of the Tutton's salt crystallizing (e.g., the nickel-containing salt(s)) were relatively longer at the leachate's adjusted pH of about 3. This was a surprising result, because the expectation, based on the common understanding in the art, was that the two types of precipitates would have substantially the same deposition times, namely, less than two hours. In contrast, this difference in precipitation times-achieved by the methods disclosed herein-allow for the economical separation of the impurities fraction (e.g., Fe, Al, and/or Zn) from the metals-of-interest fraction (e.g., Ni, Co) of the lithium-ion battery leachate. Accordingly, the processes disclosed herein (including process 100) enables the impurity metals (e.g., Fe, Al, and/or Zn) to first be precipitated (e.g., as phosphate precipitates) and collected and, then, the metals-of-interest (e.g., Ni, Co) to be crystallized, precipitated, and collected (e.g., as nickel-including Tutton's salt(s), such as Ni/Co Tutton's salt(s)) as at least one fraction separate from the fraction with the impurities metals.

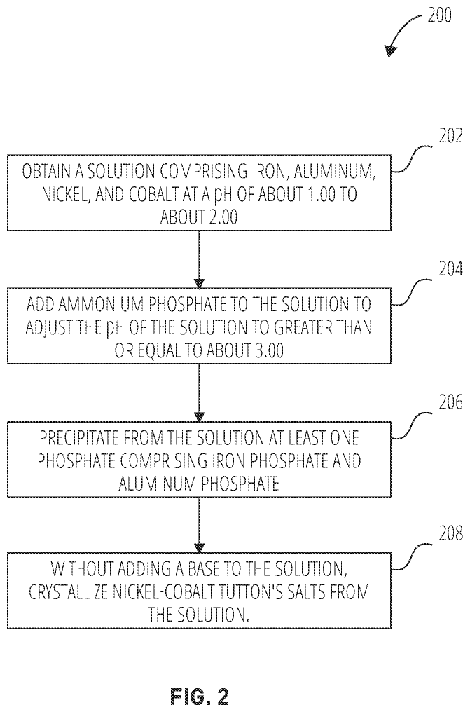

FIG. 2 is a flow diagram for a process 200 of separating dissolved metals from a solution according to embodiments of this disclosure. The process 200 includes act 202 of obtaining a solution comprising iron, aluminum, nickel, and cobalt at a pH of about 1.00 to about 2.00. The process 200 includes an act 204 of adding (e.g., mixing in) to the solution, ammonium phosphate to adjust the pH of the solution to greater than or equal to about 3. The process 200 also includes an act 206 of precipitating from the solution at least one phosphate (e.g., as a white precipitate) comprising iron phosphate and aluminum phosphate following the addition of the ammonium phosphate. In an act 208, without adding a base to the solution (e.g., after act 206), nickel-cobalt Tutton's salts are crystallized from the solution.

With regard to act 202, the obtained solution comprises iron, aluminum, nickel, and cobalt, dissolved in solution at a pH of about 1.00 to about 2.00. The solution may be a lithium-ion battery leachate. The solution may be an aqueous solution. The solution may also include sulfate ions, e.g., from H₂SO₄. For example, the solution may be obtained by soaking mechanically shredded lithium-ion batteries in an aqueous, acidic solution to extract metals from the mechanically shredded material. In some examples, the metals are the cathode materials, e.g., nickel, cobalt, and/or manganese. In some embodiments, copper and also, optionally, carbon, are substantially removed from the solution prior to other acts in the process 200.

With regard to act 204, adding (e.g., mixing) ammonium phosphate into the solution adjusts the pH of the solution to greater than or equal to about 3 (e.g., between about 3 and about 4). The use of ammonium phosphate may avoid adding additional water to the solution. The use of ammonium phosphate may also avoid chemically shocking the solution and forming insoluble precipitates that cannot be dissolved back into the solution. The ammonium phosphate may be added in small amounts (e.g., 0.25 grams per 40 mL of solution) to facilitate dissolution of the ammonium phosphate into the solution. The solution may be subject to heating and/or agitation to facilitate dissolving the ammonium phosphate into solution. If the addition of the ammonium phosphate results in the precipitation of a dark blue or violet precipitate, this dark blue or violet precipitate may be resolubilized by heating and/or agitation of the solution.

With regard to act 206, at least one phosphate—comprising iron phosphate and aluminum phosphate—may be precipitated from the solution, e.g., as a white precipitate comprising iron phosphate and aluminum phosphate. The precipitate(s) may be feathery and/or cloudy. The precipitate(s) may form readily after the pH of the solution reaches about 3. Once formed, the precipitate(s) may be diffused throughout the solution, and the solution may be centrifuged to separate the precipitate(s) from the remaining leachate solution. Alternatively, the precipitate(s) may be filtered to remove the precipitate(s) from the solution. For example, a vacuum flask with a filter support may be procured. A suitable dimensioned filter may be placed on the support. The solution may be gradually poured onto the filter and passed through the filter support using the applied vacuum of the flask. As a result, the precipitate(s) may remain on the filter from which the precipitate(s) may be collected. The solution remaining after removal of the precipitate(s) may be collected in the flask and stored until nickel (and cobalt) crystallizes as Tutton's salt(s) (act 208). Alternately, the precipitate(s) can be separated from the solution by centrifuging and then decanting the solution, leaving the precipitate(s) behind.

In an example embodiment, the precipitate(s) (e.g., the at least one phosphate) was centrifuged and the solution decanted. The precipitate(s) was placed on a vacuum support and rinsed. The rinsed precipitate(s) was resolubilized in aqua regia. The three solutions (i.e., the decanted solution, the filtrate (rinse solution of the precipitate), and the resolubilized precipitate) were analyzed by atomic absorbance spectroscopy. The liquid phase (e.g., the decanted solution) contained the majority of the lithium, copper, manganese, cobalt, nickel, and zinc from the originally obtained solution. The digestate (i.e., the precipitate(s) resolubilized in aqua regia) contained most of the aluminum and iron from the originally obtained solution. These findings were consistent with the precipitate(s) being aluminum phosphate and iron phosphate. The precipitate(s) made up 82.46 wt. % of the aluminum and 94.52 wt. % of the iron in the total of the three solutions. In contrast, the precipitate(s) was only 0.13 wt. % of the lithium, 0.27 wt. % of the cobalt, and 0.20 wt. % of the nickel in the total of the three solutions. These findings showed a strong selectivity in the precipitation. The filtrate had material weights and composition consistent with diluting the liquid phase. The filtrate did not show evidence of solubilization of the precipitate(s) during rinsing.

With regard to act 208 of the process 200, the nickel (and cobalt) Tutton's salts are crystallized from the solution that remains after precipitating the at least one phosphate from the leachate solution (act 206). The crystallization of the nickel-cobalt Tutton's salts may be achieved without adding any base to the solution (e.g., after precipitating the at least one phosphate in act 204 and/or after obtaining the solution in act 202). In some embodiments, no additional chemicals are added between precipitating the at least one phosphate (act 206) and crystallizing the nickel-cobalt Tutton's salt(s) (act 208). The nickel Tutton's salts may crystallize as blue-green crystals. In some embodiments, the Tutton's salts crystallize without further heating or agitation (e.g., after the precipitation and/or removal of the at least one phosphate precipitate(s)). The nickel-containing Tutton's salts may be formed by letting the solution stand (e.g., unagitated) at room temperature (e.g., a temperature between about 20° C. and about 25° C.). This may allow for nickel (and cobalt) to be crystallized with minimal energy or chemical requirements beyond those used to precipitate the iron phosphate and aluminum phosphate. The major difference in separating the nickel-containing Tutton's salt is the time frame (e.g., duration of time). The white precipitate of the iron phosphate and aluminum phosphate may precipitate relatively quickly as a diffuse, feathery precipitate. In contrast, the nickel-containing salt may crystallize and take a relatively longer period of time (e.g., three days). Nonetheless, the relatively longer period of time for crystallization of the Tutton's salts may be significantly shorter than time periods that would likely be involved if attempting to separate nickel and cobalt using conventional techniques.

In an example embodiment, different amounts of ammonium phosphate (e.g., 1 gram, 1.5 grams, and 2 grams) were used with a consistent amount of LIB leachate. A metals analysis of crystals grown (i.e., crystallized Tutton's salts) showed a consistent Ni:Co molar ratio of between 3.4 to 4. The salts were about 1% iron with no aluminum. The Tutton's salts included a small amount of (about 0.6 at. %) manganese and trace amounts of (about 0.1 at. % to about 0.2 at. %) zinc and lithium. No copper was found in the analysis.

Analysis of the Tutton's salt crystals by x-ray crystallography was not easily resolved due to the one-proton difference between cobalt and nickel and the one-proton difference between sulfur and phosphorous. The result was a crystal cell that could have been nickel and sulfate groups. High performance liquid chromatography (HPLC) testing showed the crystals to be mostly sulfate over phosphate (between 40:1 and 100:1 ratio of sulfate:phosphate). The significantly greater amount of sulfate, compared to phosphate, in the Tutton's salt was unexpected given that the crystals crystallized in response to an addition of a phosphate (e.g., the ammonium phosphate) to the leachate. Accordingly, the chemical analysis indicated that the crystals formed (from act 208) were present as Tutton's salts, rather than regular (e.g., single-metal) phosphates or regular sulfate salts.

The described process (e.g., process 200) enabled effective separation of metals from both nickel-rich and cobalt-rich leachates. As lithium-ion battery leachates may vary between nickel-rich and cobalt-rich, with unknown preferences in the future, the robustness of the described approach (e.g., process 200, as well as other processes disclosed herein) is beneficial.

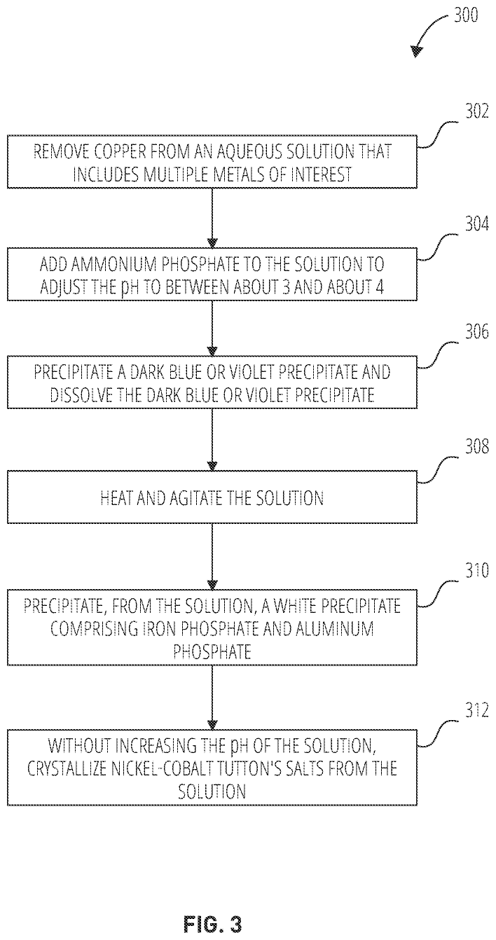

FIG. 3 is a flow diagram for a process 300 according to embodiments consistent with this disclosure. The process 300 includes act 302 of removing copper from the leachate (e.g., the leachate solution, which may be an aqueous solution that includes multiple metals of interest). Then, in an act 304, the pH of the solution is adjusted to between about 3 and about 4. The copper is removed (in act 302) before adjusting the pH of the solution (in act 304) so as to avoid precipitating copper with the iron and aluminum in a subsequent act. In act 302, the copper may be removed by solvent extraction or may be removed by precipitation.

With regard to act 304, ammonium phosphate is added to the leachate solution to adjust the pH to between about 3 and about 4.

In an act 306, a dark blue or violet precipitate is formed and precipitated and then dissolved (e.g., re-dissolved) without yet precipitating a white precipitate comprising iron phosphate and aluminum phosphate.

In an act 308, the solution is heated and agitated. This heating and agitation stage (act 308) is subsequent to the addition of the ammonium phosphate (act 304).

With returned regard to act 304, the ammonium phosphate added to the solution to adjust (e.g., increase) the pH to between about 3 and about 4 may be added incrementally to provide opportunity for the solution to homogenize after the additions. For example, the ammonium phosphate may be added in (e.g., sequential, separate) doses of 0.25 grams per 40 mL of solution. The ammonium phosphate may comprise, consist essentially of, or consist of ammonium dihydrogen phosphate or diammonium hydrogen phosphate. The ammonium phosphate may be added as a solid (e.g., as a powder). The use of a powder to adjust pH limits may avoid needing to add water (or another liquid) to the leachate. The use of a powder may also limit the potential for pH shock.

With returned regard to act 306, the dark blue or violet precipitate may be precipitated and re-dissolved prior to precipitating the white precipitate comprising iron phosphate and aluminum phosphate (in act 310). Following the presence of the dark blue or violet precipitate, the leachate may be heated and agitated (act 308) to produce a more uniform solution. This may, in turn, provide a more uniform pH in the solution, which may encourage the dissolution of the dark blue or violet precipitate (act 306). Accordingly, although FIG. 3 illustrates the heating and the agitation of the solution (act 308) as a separate act that follows the precipitation and dissolution of the dark blue or violet precipitate (act 306), in some embodiments, the heating and the agitation (act 308) may be concurrent with the precipitation and/or dissolution of the dark blue or violet precipitate (act 306). Re-dissolving the dark blue or violet precipitate (in act 306) may induce the white precipitate to form (act 310).

With further regard to act 308, the heating and agitating of the solution may be performed after (e.g., immediately after or otherwise subsequently after) the addition of the ammonium phosphate (act 304). Heating and agitation may be useful to help dissolve the dark blue or violet precipitate that may form (act 306) after the addition of the ammonium phosphate (act 304). That is, the ammonium phosphate's addition (act 304) may induce localized formation of the dark blue or violet precipitate in the solution (act 306). In some examples, the agitation and/or heating (act 308) may serve to re-dissolve the dark blue or violet precipitate back into solution (act 306). In some embodiments, the dark blue or violet precipitate is cobalt phosphate that is locally concentrated at the surface of the ammonium phosphate particles added to the solution.

In some embodiments, the heating of act 308 may be kept below about 60° C. A temperature below about 60° C. may be a sufficient temperature to encourage the dissolution of the dark blue or violet precipitate that may form (act 306) with the addition of the ammonium phosphate to the solution (act 304). In some examples, the use of lower temperatures, e.g., from about 30° C. to about 40° C., in act 308 may be sufficient to facilitate the dissolution (act 306).

The agitation of act 308 may be mechanical agitation or ultrasonic agitation. With regard to mechanical agitation, the agitation may be mechanical stirring induced by a mechanical stirring device. The agitation may be induced stirring, for example, from swirling a container containing the solution. For processing larger quantities of solution, other processes may be employed for agitation, including spin vanes, mechanical stirring, gas-based agitation (e.g., sparging), pump-based agitation, etc. In some examples, ultrasonic agitation is used to increase the diffusion rate of materials in the solution. The use of ultrasonic agitation may increase the rate that pH differences are homogenized across the solution. This may, in turn, favor the formation of the white precipitates (i.e., iron phosphate and aluminum phosphate) (act 310) after adjusting the pH with ammonium phosphate (act 304). The agitation (of act 308) may reduce the tendency to form dark blue or violet precipitate (act 306) by homogenizing the solution after the addition of the ammonium phosphate (act 304).

With further regard to act 310, the white material precipitated from the solution comprises iron phosphate and aluminum phosphate. In some embodiments, the white precipitate may also comprise zinc phosphate. The white precipitate may be feathery. Once formed, the white precipitate may be separated from the solution by centrifuging the solution to compact the precipitate. Then, the white precipitate may be separated from the solution by filtering.

After precipitating the phosphate precipitate (act 310)—and without increasing the pH of the solution (e.g., without adding basic chemicals)—nickel-cobalt Tutton's salts are crystallized from the solution (act 312). The Tutton's salts may include a blue-green color crystal. The Tutton's salt(s) may form as crystals from the solution. In some embodiments, the Tutton's salts may form over multiple days, e.g., three days. The Tutton's salts may be crystallized at room temperature. In some embodiments, the Tutton's salts crystallize in a static, non-agitated solution.

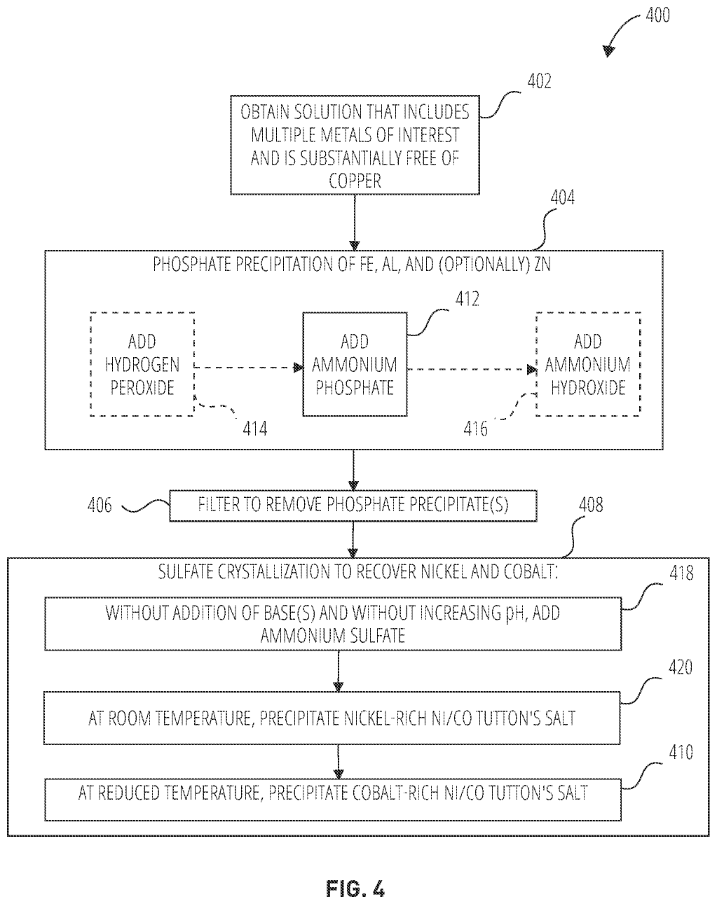

FIG. 4 is a flow diagram for a process 400 of separating dissolved metals from a solution according to embodiments of this disclosure. The process 400 of FIG. 4 may include the above-described acts of the process 100 of FIG. 1, of the process 200 of FIG. 2, and/or of the process 300 of FIG. 3, as well as additional acts illustrated in FIG. 4 and described further herein.

Process 400 includes obtaining a solution that includes multiple metals of interest and that is substantially of copper (act 402). Accordingly, the descriptions of act 102 of process 100 (FIG. 1), of act 202 of process 200 (FIG. 2), and of act 302 of process 300 (FIG. 3) may equally apply to act 402 of process 400.

In some embodiments, the metals of interest in the obtained solution include nickel (Ni) and cobalt (Co). In some such embodiments, the metals of interest further include manganese (Mn) and/or lithium (Li).

In some embodiments, the obtained solution may be free (e.g., substantially free) of both copper (Cu) and carbon (e.g., graphite).

The obtained solution (from act 402) is then subjected to a stage of phosphate precipitation of at least one impurity metal (e.g., Fe, Al, and (optionally) Zn), in stage 404. The phosphate precipitation stage includes adding ammonium phosphate (act 412) to adjust the pH of the solution to about 3.00 (e.g., between about 3.00 and about 4.00). Accordingly, the descriptions of acts 104 (FIG. 1), 204 (FIG. 2), and 304 (FIG. 3) may equally apply to act 412.

The ammonium phosphate may be added (in act 412) in the form of diammonium phosphate (DAP). In some embodiments, no additional water or other liquid is added along with the ammonium phosphate (act 412). Adding the DAP (act 412) may stabilize the pH of the leachate solution at about 3.

In some embodiments, the phosphate precipitation stage 404 of the process may further include addition of hydrogen peroxide (H₂O₂). In some such embodiments, the hydrogen peroxide may be added to the obtained solution prior to addition of the ammonium phosphate (act 412).

In embodiments including addition of hydrogen peroxide, the hydrogen peroxide may be added in a stoichiometric amount relative to the iron (Fe) present in the obtained solution. With the addition of hydrogen peroxide, Fe(II) species present in the obtained solution (act 402), if any, may be oxidized (e.g., chemically oxidized) to Fe(III). Fe(III) may more efficiently precipitate as a phosphate, relative to the precipitation of Fe(II) as a phosphate, once the ammonium phosphate salt has been added (act 412).

For an illustrative example implementing the hydrogen peroxide addition act 414 and the ammonium phosphate act 412 of the phosphate precipitation stage 404 of the process 400 of FIG. 4, a surrogate solution with pH 2 was prepared using only Co, Ni, Fe, and Al sulfates, where the Fe was in the form of Fe(II). To accelerate Fe(II) oxidation, stoichiometric amounts of H₂O₂ (about 28 μL of 30 wt. % H₂O₂) were added to the surrogate solution (act 414). Then, DAP was added (about 0.012 g DAP/mL surrogate solution) to adjust the pH of the surrogate solution to about 4. Due to the H₂O₂ addition to oxidize the Fe(II) to Fe(III), the iron (Fe, as Fe(III)) was precipitated with 99.5% efficiency (e.g., 99.5 wt. % recovery) upon the pH adjustment. In addition, 100 wt. % Al precipitation was achieved, and less than 5 wt. % Co and Ni were lost to the phosphate precipitate(s). Also, a relatively lower amount of DAP was needed to be added to adjust the pH of the solution to 4 in light of the addition of the H₂O₂, compared to examples in which no H₂O₂ was added. It is contemplated that, when H₂O₂ is added to the solution (act 414), it consumes protons, as reflected in the following equation, resulting in a lower DAP requirement for pH adjustment.

H₂O₂+2Fe²⁺+2H→2Fe³⁺+2H₂O

The addition of H₂O₂ (act 414) before the pH adjustment (e.g., addition of ammonium phosphate in act 412) also resulted in less Co and Ni co-precipitation with Al and Fe.

With continued reference to the phosphate precipitation stage 404 of the process 400 of FIG. 4, in some embodiments, ammonium hydroxide (NH₄OH) is added in an act 416—after the ammonium phosphate has been added to adjust the pH of the leachate solution to about 3 (act 412)—to further adjust (e.g., increase) the pH of the leachate to about 4. In such embodiments, the NH₄OH may be added in the form of an aqueous solution.

In embodiments including both addition of ammonium phosphate (act 412) and addition of ammonium hydroxide (act 416), the combined (e.g., sequenced) DAP and NH₄OH additions may reduce the quantities of phosphate (e.g., ammonium phosphate, such as DAP) needed to achieve an ultimate adjusted pH of about 4 without significant losses of desired metals in the phosphate precipitates (e.g., the impurity metal compounds). In such embodiments, over 95 wt. % of the Al and Fe (from the originally obtained leachate solution (act 402)) may be recovered, and less than 10 wt. % of the Co and Ni (from the originally obtained leachate solution (act 402)) may be lost in the phosphate precipitates of stage 404. Accordingly, adding both ammonium phosphate (e.g., DAP) (act 412) and ammonium hydroxide (NH₄OH) (act 416) to adjust the pH of the solution to about 4 may enable separation (and removal) of substantially all impurity metals (e.g., substantially all Fe and Al) from the solution at pH 4 while also minimizing loss of Co and Ni from the solution at this stage.

In some embodiments, should the obtained solution (act 402) include some trace amount of Cu and/or Zn, over 50 wt. % of these species may also be separated (e.g., precipitated) and recovered during the phosphate precipitation stage 404 that includes both ammonium phosphate addition (act 412) and ammonium hydroxide addition (act 416).

Subsequent to the phosphate precipitation stage 404, the phosphate precipitate(s) may be removed in act 406, such as by filtration. Additionally or alternatively, the above-descriptions of acts that remove phosphate precipitates from the leachate solution (e.g., with regard to the process 100 of FIG. 1 (e.g., by act 108), the process 200 of FIG. 2, and/or the process 300 of FIG. 3 may equally apply to act 406 of the process 400 of FIG. 4.

After removal of the fraction(s) comprising the phosphate precipitate(s) (e.g., the phosphate salts of the metal impurities, such as Fe, Al, and, in some embodiments, also Zn), the process 400 continues with a sulfate crystallization stage 408 to recover metals of interest, such as nickel (Ni) and cobalt (Co).

In some embodiments, the sulfate crystallization stage 408 may be carried out in substantially the same manner as described above with regard to act 110 of the process 100 of FIG. 1, with regard to act 208 of the process 200 of FIG. 2, and/or with regard to act 312 of the process 300 of FIG. 3. Accordingly, in some embodiments, the nickel and cobalt may be crystallized, separated from the solution, and recovered in at least one fraction in the form of at least one nickel-cobalt Tutton's salt, and this may be accomplished without the addition of additional chemicals, without the addition of base(s), and/or without otherwise increasing the pH of the solution since the precipitation of the phosphate salts.

In other embodiments, the sulfate crystallization stage 408 may include an act 418 that involves addition of ammonium sulfate and separation and collection of multiple Ni/Co Tutton's salts as separate fractions, a first being nickel-rich and a second being cobalt-rich. As with the other processes, this stage 408 may not include addition of any bases and may also not include increasing the pH of the solution subsequent to the precipitation and filtration of the phosphate precipitates (stage 404 and act 406, respectively). During the sulfate crystallization stage 408 the pH of the solution may be between about 2.00 and about 5.00, e.g., between about 2.00 and about 4.00, e.g., between about 2.00 and about 3.00. Even at this relatively low pH, the nickel and cobalt Tutton's salts may crystallize and precipitate in a sufficient time frame (e.g., within minutes for the nickel-rich fraction, to within days (e.g., about two days) for the cobalt-rich fraction).

The addition of ammonium sulfate in act 418 of the sulfate crystallization stage 408 may hasten the formation of at least one Tutton's salt and may increase the concentration of nickel relative to cobalt in one or more of the Tutton's salts formed. For example, addition of the ammonium sulfate may enable a nickel-rich Ni/Co Tutton's salt to crystallize and precipitate—such as with the solution at substantially room temperature (e.g., within a range from about 20° C. to about 25° C.)—within a relatively fast time frame (e.g., about 15 mins.). As used herein, a “nickel-rich” material (e.g., a nickel-rich Ni/Co Tutton's salt) comprises more than about 50 at. % nickel (e.g., more than 50 at. % nickel). In some embodiments, the nickel-rich Ni/Co Tutton's salt may comprise about 60 at. % nickel (e.g., about 58.4 at. % Ni), about 37 at. % cobalt (e.g., about 36.9 at. % Co), about 3 at. % manganese (e.g., about 3.1 at. % Mn), and only trace amounts (e.g., less than about 1 at. % each) of other metals, such as Li, Al, Fe, and Zn. The nickel-rich Ni/Co Tutton's salt may be substantially free of Cu (due to removal of copper from the leachate prior to stage 404); Fe, Al, and Zn (other than trace amounts, due to stage 404); and cadmium (Cd). The nickel-rich Ni/Co Tutton's salt may be in the form of green crystals.

After the precipitation of the nickel-rich Ni/Co Tutton's salt at room temperature (act 420) and removal of the salt (e.g., by filtration), the remaining solution may be cooled (e.g., refrigerated to about 9° C.) and, in about two days (e.g., about three days), a cobalt-rich Ni/Co Tutton's salt may crystallize and precipitate (act 410). As used herein, a “cobalt-rich” material (e.g., a cobalt-rich Ni/Co Tutton's salt) comprises more than about 50 at. % cobalt (e.g., more than 50 at. % cobalt). In some embodiments, the cobalt-rich Ni/Co Tutton's salt may comprise about 57 at. % cobalt (e.g., about 57.0 at. % Co), about 30 at. % nickel (e.g., about 28.9 at. % Ni), about 11 at. % manganese (e.g., about 11.6 at. % Mn), and only trace amounts (e.g., less than about 2 at. % each) of other metals, such as Li, Al, Fe, and Zn. The cobalt-rich Ni/Co Tutton's salt may be substantially free of Cu (due to stage 404); Fe, Al, and Zn (other than trace amounts, due to stage 404); and cadmium (Cd). The cobalt-rich Ni/Co Tutton's salt may be in the form of red crystals. The cobalt-rich Ni/Co Tutton's salt may be removed from the leachate, such as by filtration.

In some embodiments, the ammonium sulfate is added, in act 418, at a molar ratio, relative to the amount of metal (e.g., nickel and/or cobalt) in the leachate, of at least about 1:1. In effect, a 1:1 molar ratio (e.g., 1 mol ammonium sulfate to 1 mol Ni/Co) addition of the ammonium sulfate in act 418 may cause the crystallization and precipitation of the Ni/Co Tutton's salt at a relatively faster rate than the salt would otherwise form. Increasing the molar ratio of the ammonium sulfate (e.g., increasing the concentration of ammonium sulfate in the addition), for the addition of act 418, may result in further increased crystallization and fractional precipitation with nickel and cobalt, wherein temperature (e.g., room temperature, refrigerated temperature) may favor nickel over cobalt in the Tutton's salt formation. Accordingly, the crystallization time for the Tutton's salt(s) formation may be shortened by adding a relatively higher concentration of ammonium sulfate to the leachate. Therefore, the concentration (e.g., molar ratio) of the ammonium sulfate addition and the other conditions of the addition of act 418 (e.g., the temperature of the solution) may be controlled to tailor the relative nickel-to-cobalt concentration in the formed Ni/Co Tutton's salts and the time frame for forming and precipitating the salts.

After forming the Ni/Co Tutton's salt(s) and, in at least some embodiments, removing them from the leachate, the remaining leachate solution, which may comprise lithium, may be further processed in some embodiments to recover the lithium, such as by using conventional techniques.

The process 400 of FIG. 4, including the phosphate precipitation stage 404 and the sulfate crystallization stage 408, may achieve recovery of about 99 wt. % of the iron and aluminum, about 99 wt. % of the nickel, and about 89 wt. % of the cobalt from the original, obtained leachate solution (act 402). Moreover, by the sulfate crystallization stage 408 of the process 400 of FIG. 4, relatively high-purity nickel-cobalt materials are derived, and these materials may be suitable—e.g., without additional metal separation—for use in metal components (e.g., electrodes) of new (e.g., made-from-recycled-materials) lithium-ion batteries.

Accordingly, disclosed is a method for recovering impurity metals (e.g., Fe, Al, and, in some embodiments also Zn) and metals of interest, in a multi-stage process that provides the impurity metals in a fraction comprising phosphate salts and that provides the metals of interest (e.g., Ni and Co) in one or more fractions comprising Ni/Co Tutton's salts. In some embodiments, the separation of the impurity metals and of the metals of interest (e.g., in the Ni/Co Tutton's salts) is accomplished in a relatively short, total time frame (e.g., within about 2 days (48 hours) of initiating the phosphate precipitation(s) (act 404)), such as in embodiments including addition of ammonium sulfate (act 418) for Ni/Co Tutton's salt(s) formation). Moreover, these results may be achieved in a process (e.g., process 400) that may not involve addition of base(s) (e.g., NaOH) or, in at least some embodiments, addition of sodium (e.g., Na) ions and/or potassium (e.g., K) ions.

While the methods discussed above and/or illustrated in the figures may be described with regard to a single “pass” of the originally obtained leachate through the stages to separate impurity metal(s) and then metals of interest, in some embodiments, one or more of the stages may be repeated with some or all of the solution derived from already performed stages to further separate out impurity metal(s) and/or metals of interest from the solution. For example, after initially completing the crystallization and separation of Ni/Co Tutton's salt(s) from the solution, the solution may be again subjected to the phosphate precipitation stage(s) (e.g., with addition of more ammonium phosphate and, optionally, addition of more hydrogen peroxide and/or ammonium hydroxide) and/or again subjected to the crystallization stage(s) (e.g., with addition of more ammonium sulfate) to further separate additional amounts of the impurity metals and/or metals of interest, if any remained in the solution after the first iterations of such stage(s).

### ADDITIONAL EXAMPLES

### Example 1

A cobalt-rich lithium-ion battery leachate solution was used for the phosphate precipitation. The leachate had a pH of 1.82 and a reddish color. Ammonium dihydrogen phosphate ((NH₄)H₂PO₄) was used for this experiment. Approximately 40 mL of this leachate was transferred to a 50 mL centrifuge tube. Then, 0.502 grams of the ammonium dihydrogen phosphate was weighed and placed into the tube. This compound did not immediately dissolve in the leachate solution, and upon mixing the white crystals formed blue or violet solids in solution. After mixing for 5 minutes, the solids slightly dissolved into solution (pH˜2.3). The solution was heated using a heating mantle to increase the temperature of the solution. Repetitive mixing and heating helped in dissolving the colored solids. After 10 minutes of this procedure, the colored solids started to change and a hazy white precipitate formed in the solution. It took another 30 minutes of mixing and heating to about 40° C. to dissolve most solids. The pH of this solution was measured as 3.23. Again, these solids formed a white feathery precipitate in this solution, and the solids were pronounced where the haziness was forming white precipitates. This solution in the centrifuge tube was left overnight for the solids to settle, and was checked for any other changes (e.g., pH, colored precipitate).

From the solution, the pH changed slightly to a pH of 3.3-3.4, overnight. However, the precipitates did not show any color in them. This solution was centrifuged at 4500 rpm for 10 minutes to compact the precipitates. After compaction, there were no visible colored solids.

### Example 2

Another sample of lithium-ion battery leachate solution was used for the phosphate salt precipitation. This was done with a nickel-rich leachate which had high quantities of aluminum and some iron. The nickel-rich leachate had an off greenish-brown color (not reddish like the cobalt-rich leachate of Example 1). The bottle had some solids, but the solution was not mixed. Instead, just the solution was decanted into a 50 mL centrifuge tube for these tests. The pH was measured at 1.70.

Next, 0.5 g of (NH₄)H₂PO₄ was transferred to the tube and thoroughly mixed. This time the salt seemed to dissolve more quickly than in Example 1. The pH was measured at 1.78, which was not an expected outcome, being lower than expected. Another 0.5 grams of (NH₄)H₂PO₄ was transferred into the tube and mixed. Again, this salt dissolved in about a minute. The pH was measured at 1.87. Due to the minimal pH response, 0.5 grams of (NH₄)₂HPO₄ was used. After adding the diammonium phosphate, the same observed changes and colors in the salt were present. The diammonium salt did not dissolve after rigorous mixing at room temperature, and the solution was heated on a heating mantle to about 40° C. to assist in dissolution. During this time, the salts showed the same dark blue or violet colors as before; however, these colored salts were not as pronounced. After about 15-20 minutes of mixing and heating the salt solution, the salts were completely dissolved (solution was clear), and the pH of this solution was measured at ˜2.1. This solution was mixed with another 0.5 g of (NH₄)₂HPO₄ to reach pH˜3. After the addition of these salts, the solution showed more pronounced precipitates after mixing and heating. After heating (50° C.) and mixing for about 15 minutes, the salts showed some color that seemed to fade away. However, the salt did not seem to dissolve into solution. After about 30-40 minutes of mixing and heating to 50-60° C., the solution turned cloudy, and the white salts did not show any color. These salts were more granular than the feathery precipitate. From the original amount of salt that was added, it was estimated that half of it dissolved and became the feathery solids in solution. From the previous reaction, it is assumed that the solution has reached beyond pH˜3 and possibly even higher. Due to the powdery solids and the shifting pH (from previous reaction), this solution was allowed to settle overnight.

A lot of solids were formed, and some were granular in structure. These solids did not go back into the solution, even upon heating to 60° C. The precipitate included two types of precipitates. This solution was spun down in the centrifuge at 4500 rpm for 10 minutes. Because the pH did not change (pH=1.8), this solution still needed to be neutralized. Therefore, the diammonium phosphate salt was exclusively used. The liquid solution was decanted into another 50 mL centrifuge tube and it was contacted with diammonium phosphate to reach pH of about 3. This time a 0.5 g quantity was used to raise the pH of the solution. For this contact, the salt dissolved into the solution and the solution became cloudy. However, the first attempt gave a pH of 2.0, and further salt was needed. The next two salt additions were similar but kept at 0.25 g, and each time, the salts gave a pronounced blue or violet colors in the salts. These salts were ultra-sonicated and heated to 40° C. to create a cloudy solution without any granular solids. The pH slowly changed and the 2nd attempt gave a pH of 2.1 and then the 3rd attempt gave a pH of 2.5. The final addition of salt was 0.3 g where the cloudiness was very pronounced and the final pH of about 3.

Based on these results, the salts should be added in increments and thoroughly mixed in these solutions. Using larger quantities of these ammonium phosphate salts resulted in two layers of salts. This could indicate the salt not completely reacting with the metals, for example, where the salt is encapsulated (oxide/metals) and not affected by the acid.

After three days at room temperature, a blue-green crystal was formed in the tube. Subsequent analysis showed this, surprisingly, to be a sulfate-based crystal. This was a surprise because the addition to the leachate was a phosphate (ammonium phosphate). Further analysis revealed that the blue-green crystal was a nickel Tutton's salt. The nickel Tutton's salt was formed spontaneously without heating or agitation of the solution. The nickel Tutton's salt had a distinct blue-green color which differentiated it from the iron phosphate and aluminum phosphate previously precipitated from the leachate. The blue-green color was also distinct from the dark blue or violet color salts seen with the addition of ammonium phosphate to the leachate solution.

Although the foregoing descriptions contain many specifics, these are not to be construed as limiting the scope of the disclosure, but merely as providing certain exemplary embodiments. Similarly, other embodiments of the disclosure may be devised that do not depart from the scope of the disclosure. For example, features described herein with reference to one embodiment may also be provided in others of the embodiments described herein. The scope of the embodiments of the disclosure is, therefore, indicated and limited only by the appended claims and their legal equivalents, rather than by the foregoing description. All additions, deletions, and modifications to the disclosure, as disclosed herein, which fall within the meaning and scope of the claims, are encompassed by the disclosure.

1. A method of separating metals from a lithium-ion battery leachate, the method comprising:
obtaining a solution comprising iron, aluminum, nickel, and cobalt;
adding ammonium phosphate to the solution to adjust a pH of the solution to greater than or equal to about 3.00;
after adjusting the pH of the solution to greater than or equal to about 3.00, precipitating at least one phosphate precipitate from the solution, the at least one phosphate precipitate comprising iron phosphate and aluminum phosphate; and
after precipitating the at least one phosphate precipitate from the solution and without adding a base to the solution, precipitating a crystallized nickel-cobalt Tutton's salt from the solution.

2. The method of claim 1, wherein during precipitating the crystallized nickel-cobalt Tutton's salt from the solution, the pH of the solution is within a range from about 2.00 to about 3.00.

3. The method of claim 1, further comprising, after precipitating the at least one phosphate precipitate from the solution:
filtering the solution to remove the at least one phosphate precipitate from the solution; and
after the filtering, adding ammonium sulfate to the solution,
wherein precipitating the crystallized nickel-cobalt Tutton's salt from the solution is substantially completed within about two days.

4. The method of claim 1, wherein precipitating the crystallized nickel-cobalt Tutton's salt from the solution comprises:
precipitating a first crystallized nickel-cobalt Tutton's salt from the solution; and
after precipitating the first crystallized nickel-cobalt Tutton's salt from the solution, precipitating a second crystallized nickel-cobalt Tutton's salt from the solution,
the first crystallized nickel-cobalt Tutton's salt comprising greater than about 50 atomic percent nickel, and
the second crystallized nickel-cobalt Tutton's salt comprising greater than about 50 atomic percent cobalt.

5. The method of claim 1, wherein precipitating the crystallized nickel-cobalt Tutton's salt from the solution comprises:
at a temperature within a range from about 20° C. to about 25° C., precipitating a first crystallized nickel-cobalt Tutton's salt from the solution,
lowering the temperature of the solution to below about 20° C.; and
after lowering the temperature of the solution, precipitating a second crystallized nickel-cobalt Tutton's salt from the solution,
the first crystallized nickel-cobalt Tutton's salt and the second crystallized nickel-cobalt Tutton's salt having different atomic ratios of nickel to cobalt.

6. The method of claim 1, wherein precipitating the crystallized nickel-cobalt Tutton's salt from the solution comprises precipitating a crystallized nickel-cobalt Tutton's salt comprising the nickel, the cobalt, and manganese.

7. The method of claim 1, wherein precipitating the crystallized nickel-cobalt Tutton's salt from the solution comprises precipitating a crystallized nickel-cobalt Tutton's salt comprising nickel-cobalt ammonium sulfate.

8. The method of claim 1, wherein obtaining a solution comprising iron, aluminum, nickel, and cobalt comprises obtaining an aqueous solution comprising iron, aluminum, nickel, and cobalt.

9. The method of claim 8, wherein obtaining the solution comprises obtaining a solution that is substantially free of copper.

10. The method of claim 1, wherein, during the precipitation of the crystallized nickel-cobalt Tutton's salt from the solution, the pH of the solution is between about 2.00 and about 4.00.

11. The method of claim 1, further comprising, before precipitating the at least one phosphate precipitate from the solution, adding hydrogen peroxide (H₂O₂).

12. The method of claim 1, further comprising, before precipitating the at least one phosphate precipitate from the solution, adding ammonium hydroxide (NH₄OH) to adjust the pH of the solution to about 4.00.

13. The method of claim 1, further comprising, after adjusting the pH of the solution to be greater than or equal to about 3.00, precipitating zinc phosphate from the solution.

14. The method of claim 1, further comprising, before precipitating the crystallized nickel-cobalt Tutton's salt from the solution, filtering the solution to remove the at least one phosphate precipitate from the solution.

15. The method of claim 14, wherein filtering the solution comprises removing at least about 90 weight % of the iron from the solution as originally obtained and removing at least about 90 weight % of the aluminum from the solution as originally obtained.

16. The method claim 1, wherein precipitating the crystallized nickel-cobalt Tutton's salt from the solution is completed within about three days of precipitating the at least one phosphate precipitate from the solution.

17. The method of claim 1, wherein, after obtaining the solution, all material added during a remainder of the method consists of water-soluble salts, the water-soluble salts comprising the ammonium phosphate.

18. The method of claim 1, further comprising, after adding the ammonium phosphate to the solution to adjust the pH of the solution to greater than or equal to about 3.00, heating and agitating the solution.

19. The method of claim 1, wherein throughout the method, the pH of the solution is less than about 4.00.

20. The method of claim 1, wherein adding ammonium phosphate to the solution comprises adding diammonium phosphate (DAP) to the solution.
